(19) United States
(12) Patent Application Publication
(10) Pub. No.: US 2024/0329247 A1
(43) Pub. Date: Oct. 3, 2024

(54) LASER RADAR DEVICE

(71) Applicant: DENSO CORPORATION, Kariya-city (JP)

(72) Inventors: Yuichi TOYOTA, Kariya-city (JP); Taro BEPPU, Kariya-city (JP); Chihiro MORIGUCHI, Kariya-city (JP); Naoki YOSHIMOTO, Kariya-city (JP); Hiroyuki MATSUBARA, Nagakute-shi (JP); Tatsuya YAMASHITA, Nagakute-shi (JP); Tadashi ICHIKAWA, Nagakute-shi (JP)

(21) Appl. No.: 18/744,333

(22) Filed: Jun. 14, 2024

Related U.S. Application Data
(63) Continuation of application No. PCT/JP2022/043359, filed on Nov. 24, 2022.

(30) Foreign Application Priority Data
Dec. 16, 2021 (JP) 2021-204189

(51) Int. Cl. G01S 17/42; G01S 7/4911

(52) U.S. Cl. CPC G01S 17/42; G01S 7/4911

(57) ABSTRACT

A laser radar device includes a transmission unit, a scanning unit, a distance calculation section, and a movement control unit. The transmission unit transmits laser light that has been subjected to frequency modulation. The scanning unit performs scanning with the laser light. For each of a plurality of partial regions obtained by dividing a laser light scanning region preset as a two-dimensional region which the scanning unit scans with the laser light, the distance calculation section receives the laser light that has been reflected by an object, and calculates a distance to the object in the partial region. The movement control unit controls movement of the laser light so that the laser light moves in the partial region, with Δθ>(1.22*λ/d) being met.

### REFERENCE TO RELATED APPLICATION

The present application is based on and claims the benefit of priority from earlier Japanese Patent Application No. 2021-204189 filed on Dec. 16, 2021, the description of which is incorporated herein by reference.

### BACKGROUND

### Technical Field

The present disclosure relates to a laser radar device.

### Related Art

A laser radar device is disclosed which uses an FMCW system which includes a transmission unit that transmits laser light, as transmission light, which has been modulated so as to have an up-modulation section in which a frequency linearly increases with respect to time and a down-modulation section in which a frequency linearly decreases with respect to time, and a reception unit that receives reflected light, as reception light, which is the transmission light reflected by an object.

### SUMMARY

An aspect of the present disclosure provides a laser radar device including: a transmission unit configured to transmit laser light that has been subjected to frequency modulation; a scanning unit configured to perform scanning with the laser light irradiated from the transmission unit: a distance calculation section configured to, for each of a plurality of partial regions obtained by dividing a laser light scanning region preset as a two-dimensional region which the scanning unit scans with the laser light, receive the laser light that has been transmitted from the scanning unit and reflected by an object, and calculate at least a distance to the object in the partial region; and a movement control unit configured to, for each of the plurality of partial regions, control movement of the laser light so that the laser light moves in the partial region, with Δθ>(1.22*λ)/d) being met, where Δθ is a movement angular range in which the laser light moves in the partial region, λ is a wavelength of the laser light, and d is a diameter of the laser light on the partial region.

### BRIEF DESCRIPTION OF THE DRAWINGS

In the accompanying drawings:

FIG. 1 is a block diagram illustrating a configuration of a laser radar device according to a first embodiment;

FIG. 2 is a diagram illustrating a scanning direction of the laser radar device;

FIG. 3 is a diagram illustrating movement of an irradiation spot;

FIG. 4 is a diagram for describing a movement angular range of the irradiation spot;

FIG. 5 is a flowchart of a distance measuring process according to the first embodiment;

FIG. 6 is a diagram for describing a fine section;

FIG. 7 illustrates histograms illustrating distributions of reception light intensity;

FIG. 8 is a block diagram illustrating a configuration of a laser radar device according to a second embodiment;

FIG. 9 is a diagram for describing a control method according to the second embodiment;

FIG. 10 is a diagram for describing a movement method of an irradiation spot according to the second embodiment;

FIG. 11 is a block diagram illustrating a configuration of a laser radar device according to a third embodiment;

FIG. 12 illustrates an irradiation spot moved in the vertical direction;

FIG. 13 illustrates an irradiation spot moved in the horizontal and vertical directions simultaneously;

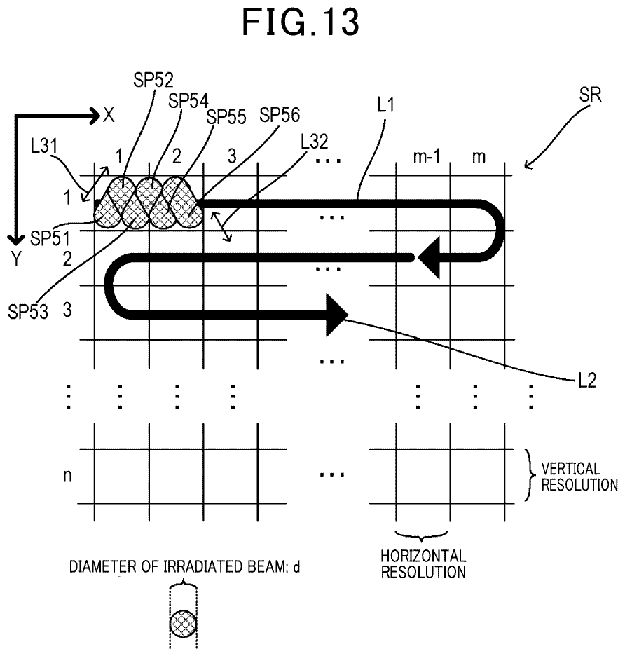

FIG. 14 illustrates a plurality of irradiation spots irradiated in one partial region;

FIG. 15 illustrates an irradiation spot moved to a region beyond one partial region; and

FIG. 16 illustrates a plurality of signal processing sections overlapping with each other.

### DETAILED DESCRIPTION OF THE PREFERRED EMBODIMENTS

US Patent Application Publication No. US2017/0356983A1 discloses a laser radar device using an FMCW system which includes a transmission unit that transmits laser light, as transmission light, which has been modulated so as to have an up-modulation section in which a frequency linearly increases with respect to time and a down-modulation section in which a frequency linearly decreases with respect to time, and a reception unit that receives reflected light, as reception light, which is the transmission light reflected by an object.

Detailed studies by the inventor found a problem that, in the laser radar device using an FMCW system, the amplitude of a beat signal varies under the influence of speckle generated by interference of laser light due to roughness of a surface of an object reflecting the laser light, whereby detection accuracy of the laser radar device decreases.

The present disclosure increases accuracy in detection of a laser radar device.

### First Embodiment

Hereinafter, a first embodiment of the present disclosure will be described with reference to the drawings.

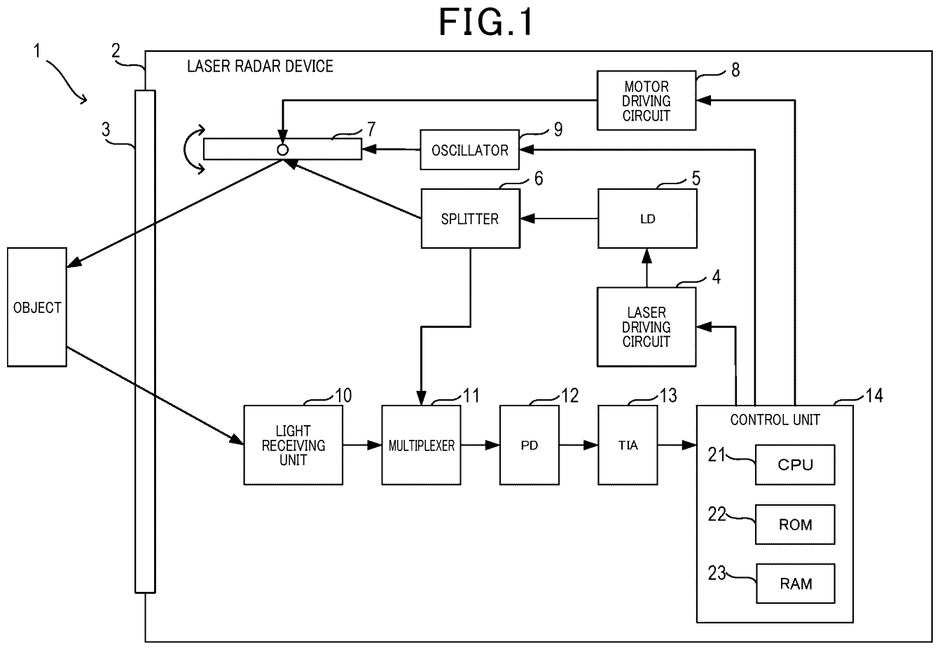

A laser radar device 1 of the present embodiment employs a well-known FMCW system, and includes, as illustrated in FIG. 1, a housing 2, an optical window 3, a laser driving circuit 4, a laser diode 5, a splitter 6, a scanning unit 7, a motor driving circuit 8, an oscillator 9, a light receiving unit 10, a multiplexer 11, a photodiode 12, a transimpedance amplifier (hereinafter, TIA) 13, and a control unit 14. FMCW is an abbreviation for “Frequency Modulated Continuous Wave”.

The housing 2 is a case having an opening through which light is passed, and accommodates therein the laser driving circuit 4, the laser diode 5, the splitter 6, the scanning unit 7, the motor driving circuit 8, the oscillator 9, the light receiving unit 10, the multiplexer 11, the photodiode 12, the TIA 13, and the control unit 14.

The optical window 3 is formed from a material through which light passes and is provided so as to close the opening of the housing 2.

In accordance with an instruction from the control unit 14, the laser driving circuit 4 outputs a driving signal, which generates laser light whose frequency is swept, to the laser diode 5.

The laser diode 5 repeatedly irradiates laser light (hereinafter, transmission light) whose frequency is swept, based on the driving signal output from the laser driving circuit 4. Specifically, the laser diode 5 generates and irradiates transmission light that has been modulated so as to have an up-modulation section in which a frequency linearly increases with respect to time and a down-modulation section in which a frequency linearly decreases with respect to time, at predetermined modulating periods Tm.

The splitter 6 is configured by, for example, a coupler in which an optical waveguide branches, and receives transmission light irradiated from the laser diode 5. The splitter 6 irradiates part of the transmission light received by the splitter 6 to the scanning unit 7 and irradiates the remaining part of the transmission light to the multiplexer 11.

The scanning unit 7 includes, for example, a vertical direction scanner and a horizontal direction scanner, which are not shown. In the vertical direction scanner, a mirror is rotated by driving force generated by a motor, which is not shown, whereby scanning is performed in the vertical direction with laser light. In the horizontal direction scanner, a mirror is rotated by driving force generated by a motor, which is not shown, whereby scanning is performed in the horizontal direction with laser light. The scanning unit 7 further subjects the laser light, with which scanning has been performed by the vertical direction scanner, to scanning by the horizontal direction scanner, thereby irradiating the laser light to the optical window 3 while subjecting the laser light to two-dimensional scanning.

In accordance with an instruction from the control unit 14, the motor driving circuit 8 outputs a driving signal, which is for generating driving force for rotating the vertical direction scanner and the horizontal direction scanner of the scanning unit 7, to the motor.

The oscillator 9 includes, for example, a piezoelectric element, and is mounted to the horizontal direction scanner of the scanning unit 7. The oscillator 9 oscillates in response to a driving signal output from the control unit 14 to oscillate the horizontal direction scanner in the horizontal direction.

The light receiving unit 10 receives reflected light, as reception light, which is the transmission light reflected by an object.

The multiplexer 11 mixes the transmission light received from the splitter 6 and the reception light received from the light receiving unit 10 to generate a beat signal.

The photodiode 12 converts the beat signal received from the multiplexer 11 to a current signal and outputs the current signal.

The TIA 13 converts the current signal received from the photodiode 12 to a voltage signal and outputs the voltage signal.

The control unit 14 is an electronic control unit mainly configured by a microcomputer including a CPU 21, a ROM 22, a RAM 23, and the like. Various functions of the microcomputer are implemented by the CPU 21 executing a program stored in a non-transitory tangible storage medium. In this example, the ROM 22 corresponds to the non-transitory tangible storage medium storing the program. Executing the program performs a method corresponding to the program. Some or all of the functions implemented by the CPU 21 may be performed by hardware such as one or more ICs. The number of microcomputers configuring the control unit 14 may be one or more.

The control unit 14 includes an A/D conversion circuit, a fast Fourier transform circuit, and the like. The control unit 14 converts the voltage signals sequentially received from the TIA 12 to digital signals and stores the values indicated by the digital signals as amplitudes of the beat signal in the RAM 23 in time series to generate beat signal waveform data indicating variation with time of the amplitude of the beat signal. Then, the control unit 14 subjects the beat signal waveform data to frequency analysis to calculate a distance and a speed of an object. In addition, the control unit 14 calculates an angle of the object based on the scanning direction of the transmission light.

In the FMCW system, as the beat signal, an up-beat signal and a down-beat signal are generated. The up-beat signal is generated by mixing the transmission light and the reception signal during a time period during which radar waves in the up-modulation section are transmitted. Similarly, the down-beat signal is generated by mixing the transmission light and the reception signal during a time period during which radar waves in the down-modulation section are transmitted.

Then, the following expressions (1) and (2) are established between a frequency fbu of the up-beat signal and a frequency fbd of the down-beat signal, and a distance L to an object (hereinafter, object distance L) and a relative speed v (hereinafter, object relative speed v). It the expressions (1) and (2), c is the speed of light, Δf is a frequency variation range of the transmission light, and f0 is a center frequency of the transmission light.

$$[ Expression 1 ]$$

$$fbu = \frac{4 * Δ f * L}{c * Tm} - \frac{2 * f 0 * v}{c} \qquad ( 1 )$$

$$fbd = \frac{4 * Δ f * L}{c * Tm} + \frac{2 * f 0 * v}{c} \qquad ( 2 )$$

Hence, the object distance L and the object relative speed v are calculated by the following expressions (3) and (4).

$$[ Expression 2 ]$$

$$L = \frac{c * Tm}{8 * Δ f} ( fbu + fbd ) \qquad ( 3 )$$

$$v = \frac{c}{4 * f 0} ( fbu - fbd ) \qquad ( 4 )$$

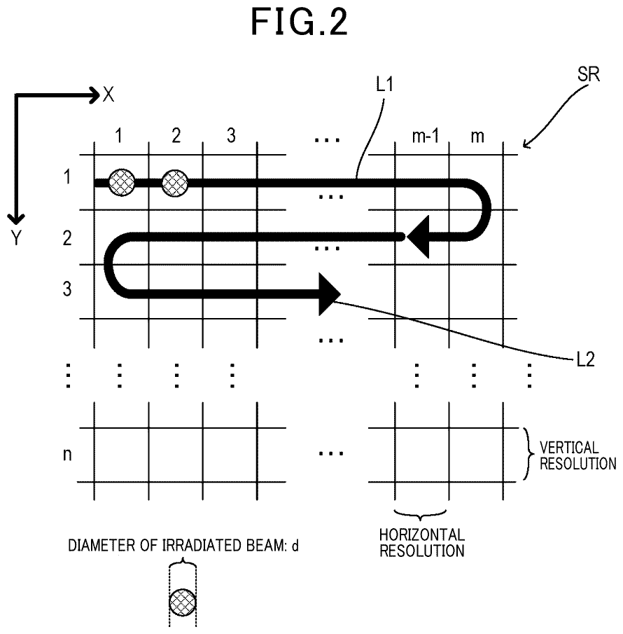

As illustrated in FIG. 2, a laser light scanning region SR to which the laser radar device 1 irradiates laser light is divided into rectangular partial regions consisting of m (m is a positive integer) partial regions in the X-axis direction, which is the horizontal direction, and n (n is a positive integer) partial regions in the Y-axis direction, which is the vertical direction.

The control unit 14 controls irradiation of laser light by the laser diode 5 and scanning with the laser light by the scanning unit 7 so that the laser irradiation position moves to the partial region adjacent in the horizontal direction every time the modulating period Tm elapses. However, when the laser light reaches the rightmost partial region or the leftmost partial region, the control unit 14 controls scanning with the laser light so that the laser light moves to the partial region immediately below that. That is, the control unit 14 performs control so that the scanning unit 7 performs raster scanning.

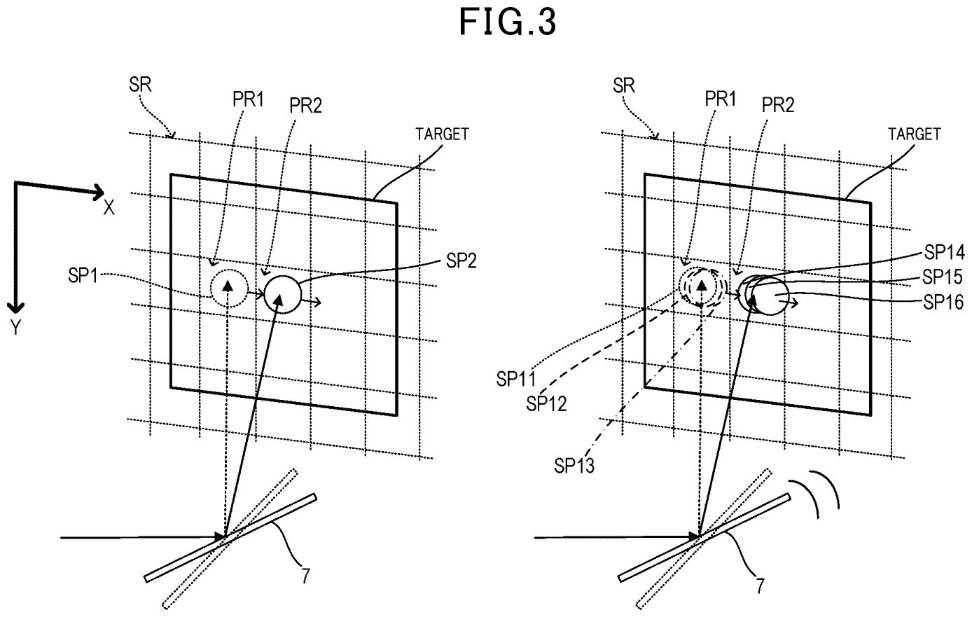

Irradiation spots SP1, SP2 in FIG. 3 illustrate shapes of laser light on a target, the laser light having been irradiated from the laser radar device 1 in a state in which the oscillator 9 is not oscillating, and having reached an object which is the target. Partial regions PR1, PR2 are two partial regions adjacent to each other in the horizontal direction. The irradiation spots SP1, SP2 are formed in the partial regions PR1, PR2, respectively. Assuming that the irradiation spot SP2 indicates an irradiation position at time t1, the irradiation spot SP1 indicates an irradiation position at time (t1-Tm).

Irradiation spots SP11, SP12, SP13, SP14, SP15, SP16 in FIG. 3 illustrate shapes of laser light on a target, the laser light having been irradiated from the laser radar device 1 in a state in which the oscillator 9 is oscillating, and having reached an object which is the target. The irradiation spots SP11 to SP13 are formed in the partial region PR1. The irradiation spots SP14 to SP16 are formed in the partial region PR2. That is, the irradiation spots move in the partial regions along the horizontal direction by oscillation of the oscillator 9.

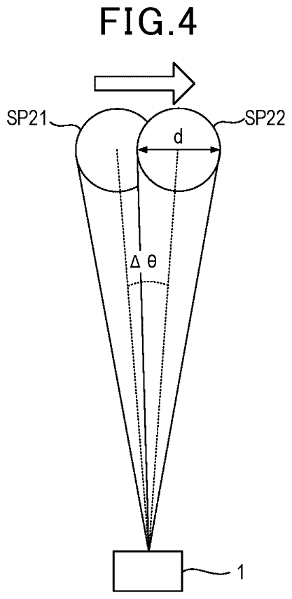

As illustrated in FIG. 4, the control unit 14 causes the oscillator 9 to oscillate between an irradiation spot SP21 located on the leftmost side and an irradiation spot SP22 located on the rightmost side in the same partial region so as to satisfy the expression (5). In the expression (5), 40 is a difference between a scanning angle of the irradiation spot SP22 and a scanning angle of the irradiation spot SP21. λ is a wavelength of laser light. d is a diameter of the irradiation spots SP21, SP22.

$$Δθ > 1.22 * λ / d \qquad ( 5 )$$

It is noted that during distance measurement, reception light intensity randomly changes depending on irradiated portions due to speckle phenomena. In contrast, if a plurality of portions where speckles are independent from each other are irradiated, reception light intensity depending on independent speckles can be expected. Hence, the condition for independence of intensity variation due to the speckles is established as the expression (5).

In the laser radar device 1 configured as described above, the control unit 14 performs a distance measuring process. The distance measuring process is performed every time the modulating period Tm elapses while the control unit 14 is in operation.

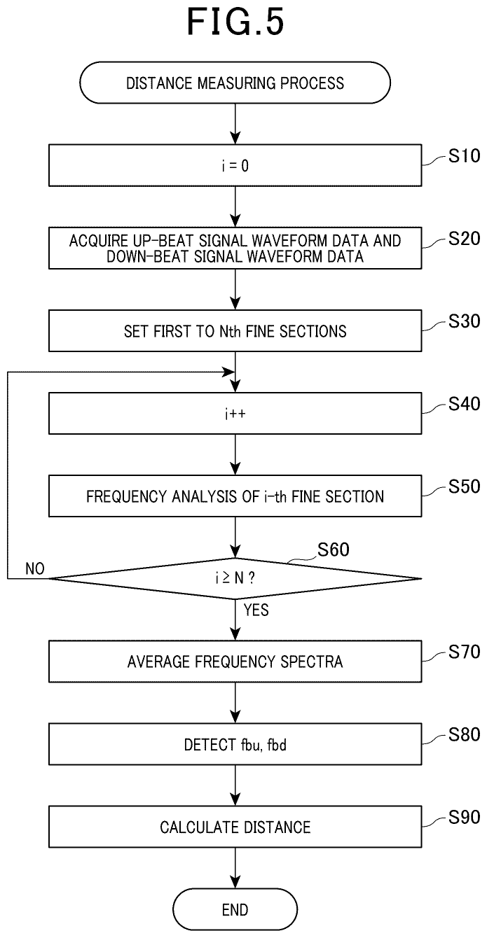

If the distance measuring process starts, as illustrated in FIG. 5, first in step S10, the CPU 21 of the control unit 14 sets a section indicator value i, which is provided to the RAM 23, to 0.

Then, in step S20, the CPU 21 acquires beat signal waveform data generated in an immediate up-modulation section (hereinafter, up-beat signal waveform data) and beat signal waveform data generated in an immediate down-modulation section (hereinafter, down-beat signal waveform data) from the RAM 23.

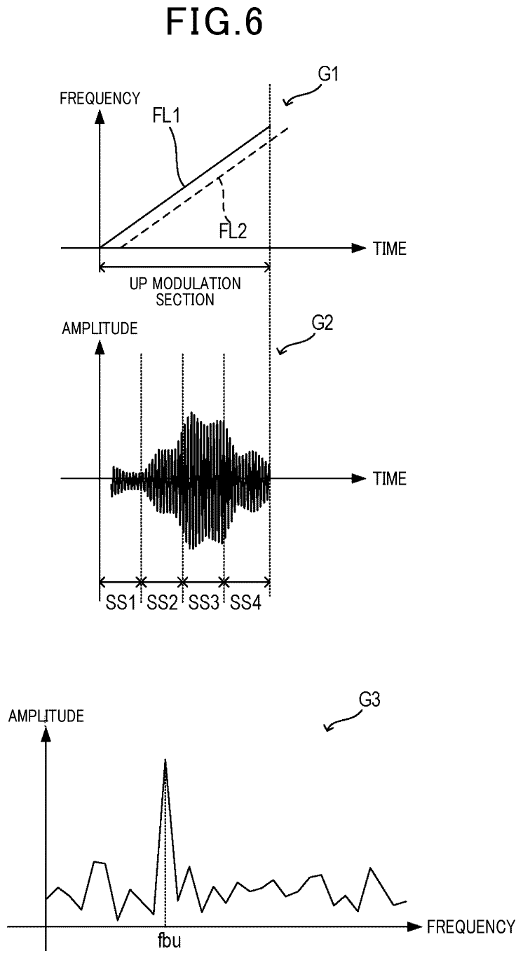

A graph G1 in FIG. 6 illustrates variation with time of frequencies of transmission light and reception light in the up-modulation section. A straight line FL1 indicates variation with time of a frequency of the transmission light. A straight line FL2 indicates variation with time of a frequency of the reception light.

Next, as illustrated in FIG. 5, in step S30, for each of the up-beat signal waveform data and the down-beat signal waveform data, the CPU 21 first sets fine sections, the number of which is a predetermined division number N and which do not overlap with each other, within a time range of each of the up-beat signal waveform data and the down-beat signal waveform data. The predetermined division number N is an integer of 2 or more. Hereinafter, the predetermined division number N of fine sections are referred to as a first fine section SS1, a second fine section SS2, . . . , and an Nth fine section SSN, respectively, in time series.

A graph G2 illustrated in FIG. 6 indicates the first fine section SS1, the second fine section SS2, the third fine section SS3, and the fourth fine section SS4, which divide a beat signal waveform in the up-modulation section.

Furthermore, as illustrated in FIG. 5, in S40, the CPU 21 increments the section indicator value i by 1 (i.e., adds 1).

Then, in step S50, the CPU 21 performs a frequency analysis process for each of the up-beat signal waveform data and the down-beat signal waveform data in the a i-th fine section SSi to calculate a frequency spectrum of the up-beat signal (hereinafter, up-frequency spectrum) and a frequency spectrum of the down-beat signal (hereinafter, down-frequency spectrum) in the i-th fine section SSi.

The frequency spectrum expresses frequencies included in a beat signal and amplitudes at the frequencies. In the present embodiment, the above frequency analysis process is fast Fourier transformation.

A graph G3 illustrated in FIG. 6 indicates a frequency spectrum calculated by performing the frequency analysis process for the up-beat signal waveform data in the third fine section SS3 in the up-modulation section.

Next, as illustrated in FIG. 5, in step S60, the CPU 21 determines whether the section indicator value i is the predetermined division number N or larger. If the section indicator value i is smaller than the predetermined division number N, the CPU 21 proceeds to step S40. In contrast, if the section indicator value i is the predetermined division number N or larger, in step S70, the CPU 21 calculates an average up-frequency spectrum obtained by averaging amplitudes of up-frequency spectra from the first fine section SS1 to the Nth fine section SSN and an average down-frequency spectrum obtained by averaging amplitudes of down-frequency spectra from the first fine section SS1 to the Nth fine section SSN.

Then, in step S80, the CPU 21 detects, as a frequency fbu, a frequency peak present on the average up-frequency spectrum calculated in step S70 and detects, as a frequency fbd, a frequency peak present on the average down-frequency spectrum calculated in step S70.

Furthermore, in step S90, the CPU 21 uses the frequency fbu and the frequency fbd detected in step S80 to calculate an object distance L, and terminates the distance measuring process.

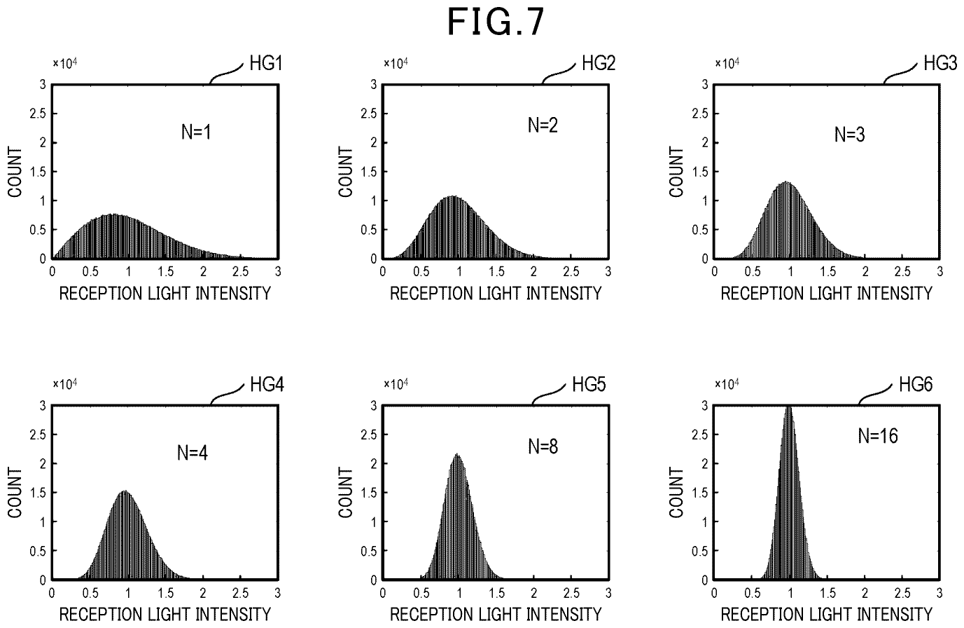

FIG. 7 illustrates histograms illustrating distributions of reception light intensity in a case in which distance measurement is performed so that laser light crosses N regions where speckles are independent from each other. The number N of regions is any of 1, 2, 3, 4, 8, and 16.

Histograms HG1, HG2, HG3, HG4, HG5, and HG6 in FIG. 7 respectively indicate distributions of reception light intensity in a case in which distance measurement is performed so that laser light crosses 1, 2, 3, 4, 8, and 16 regions. The histograms HG1 to HG6 are generated by performing a process a hundred thousand times which generates random numbers according to a Rayleigh distribution and then averages these N times.

As illustrated in FIG. 7, as the number N of regions increases (i.e., as a region which laser light crosses becomes wider), variation in the reception light intensity becomes smaller.

The laser radar device 1 configured as described above includes the laser driving circuit 4, the laser diode 5, the scanning unit 7, the control unit 14, and the oscillator 9.

The laser driving circuit 4 and the laser diode 5 are configured to transmit laser light that has been subjected to frequency modulation.

The scanning unit 7 is configured to perform scanning with the laser light radiated from the laser diode 5.

The control unit 14 is configured to, for each of a plurality of partial regions obtained by dividing the laser light scanning region SR preset as a two-dimensional region which the scanning unit 7 scans with laser light, receive laser light that has been transmitted from the scanning unit 7 and reflected by an object and calculate at least a distance to the object in the partial region.

The control unit 14 is configured to drive the oscillator 9 to control movement of laser light so that the laser light moves in the partial region, with Δθ>(1.22*λ/d) being met.

Since the laser radar device 1 described above can move an irradiation position of laser light in one partial region, for a plurality of partial regions, the influence of speckle can be averaged by averaging amplitudes of a plurality of frequency spectra at different radiation positions, whereby variation in the reception light intensity can be reduced. Hence, accuracy in detection of the laser radar device 1 can 25 be increased.

In the embodiment described above, the laser driving circuit 4 and the laser diode 5 correspond to a transmission unit, steps S10 to S90 correspond to a process as a distance calculation section, and the control unit 14 and the motor driving circuit 8 correspond to a movement control unit.

### Second Embodiment

Hereinafter, a second embodiment of the present disclosure will be described with reference to the drawings. In the second embodiment, differences from the first embodiment will be described. The common components are indicated by the same reference sign.

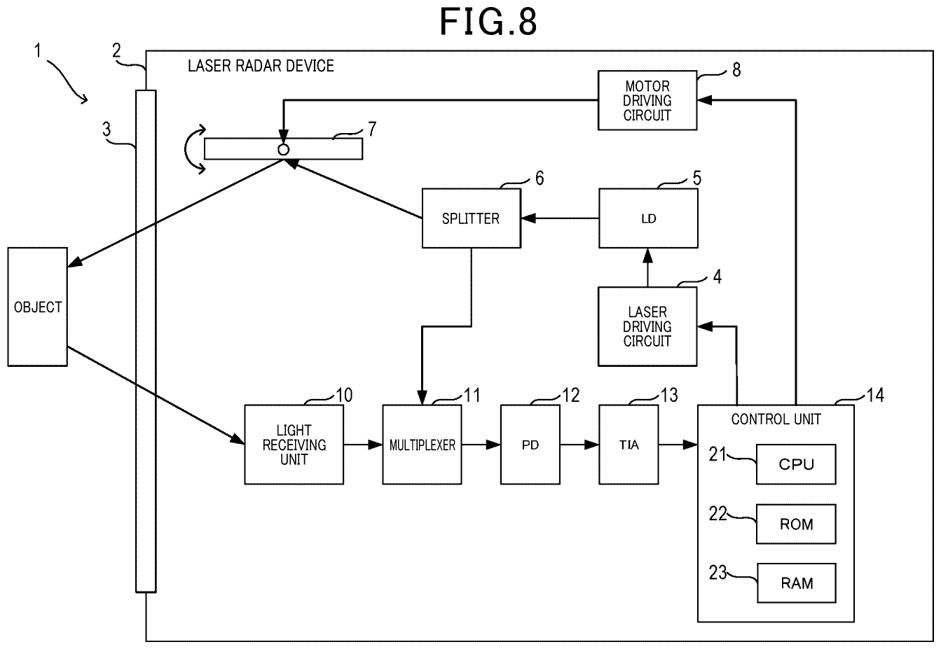

As illustrated in FIG. 8, the laser radar device 1 of the second embodiment differs from that of the first embodiment in that the oscillator 9 is removed.

Then, the control unit 14 performs feedback control so that a scanning angle of the horizontal direction scanner oscillates around a target angle to control scanning by the horizontal direction scanner.

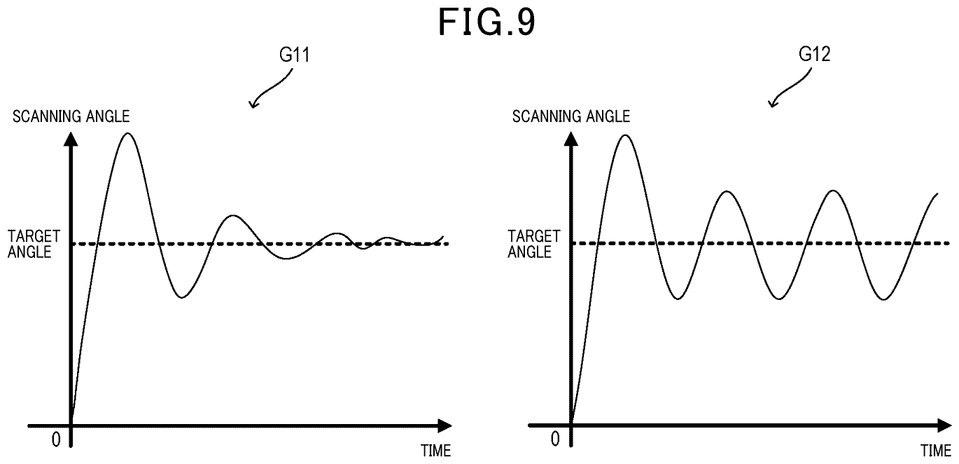

A graph G11 in FIG. 9 illustrates variation with time of the scanning angle in a case in which the scanning angle of the scanner is controlled by typical PID control. As illustrated in the graph G11, in typical PID control, the scanning angle converges to the target angle as time elapses.

A graph G12 in FIG. 9 illustrates variation with time of the scanning angle in a case in which the scanning angle of the scanner is controlled by the control unit 14 of the second embodiment. As illustrated in the graph G12, in the control performed by the control unit 14 of the second embodiment, the scanning angle does not converge to the target angle but continues to oscillate at the same amplitude centering on the target angle.

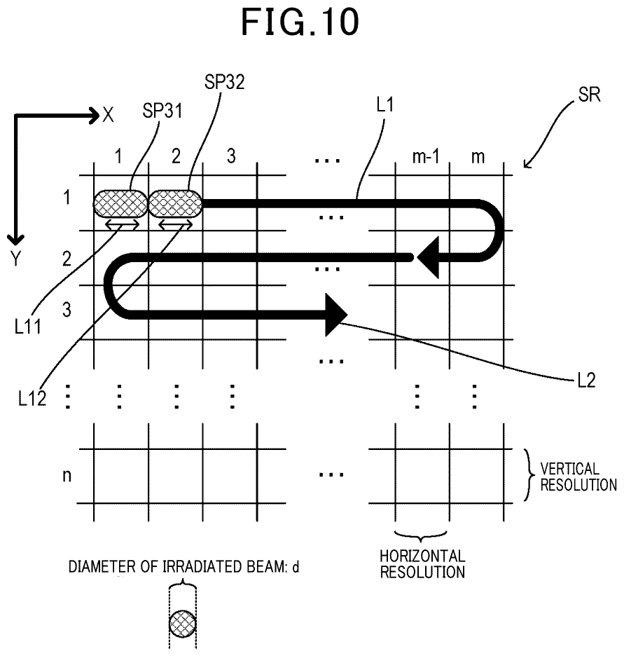

Hence, as indicated by irradiation spots SP31, SP32 and arrows L11, L12 in FIG. 10, the irradiation spots oscillate in the horizontal direction in partial regions.

In the laser radar device 1 configured as described above, the control unit 14 and the motor driving circuit 8 control the scanning unit 7 by performing, for each of a plurality of partial regions, feedback control so that a scanning angle oscillates around a target angle corresponding to the partial region to move laser light in the partial regions, with Δθ>(1.22*λ/d) being met.

Since the laser radar device 1 described above can move an irradiation position of laser light in one partial region, the influence of speckle can be averaged for a plurality of partial region, whereby variation in the reception light intensity can be reduced. Hence, accuracy in detection of the laser radar device 1 can be increased.

In the embodiment described above, the control unit 14 and the motor driving circuit 8 correspond to a movement control unit.

### Third Embodiment

Hereinafter, a third embodiment of the present disclosure will be described with reference to the drawings. In the third embodiment, differences from the first embodiment will be described. The common components are indicated by the same reference sign.

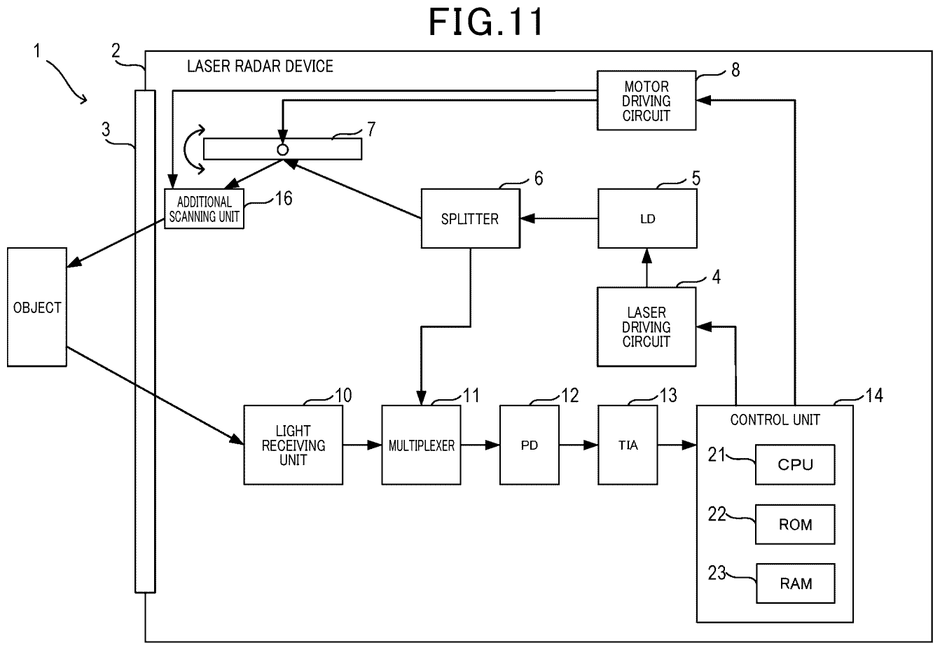

As illustrated in FIG. 11, the laser radar device 1 of the third embodiment differs from that of the first embodiment in that the oscillator 9 is removed and an additional scanning unit 16 is added.

The additional scanning unit 16 is disposed on a path from the scanning unit 7 to the optical window 3 which laser light irradiated from the scanning unit 7 reaches. In the additional scanning unit 16, a mirror is rotated by driving force generated by a motor, which is not shown, to perform scanning in the horizontal direction with the laser light radiated from the scanning unit 7. A scanning angle range of the additional scanning unit 16 is greatly less than the scanning angle range of the scanning unit 7. However, the scanning angle range of the additional scanning unit 16 meets the expression (5). That is, the scanning angle range of the additional scanning unit 16 is set to be 20) larger than 1.22*λ/d.

Then, in accordance with an instruction from the control unit 14, the motor driving circuit 8 outputs a driving signal, which is for generating driving force for rotating the additional scanning unit 16, to the motor.

Hence, the laser radar device 1 of the third embodiment can cause an irradiation spot oscillate in the horizontal direction in the partial region.

The laser radar device 1 configured as described above includes the additional scanning unit 16 configured to further perform scanning with laser light transmitted from the scanning unit 7. Then, the control unit 14 and the motor driving circuit 8 drive the additional scanning unit 16 to move the laser light in the partial region, with Δθ>(1.22*λ/d) being met.

Since the laser radar device 1 described above can move an irradiation position of laser light in one partial region, the influence of speckle can be averaged for a plurality of partial regions, whereby variation in the reception light intensity can be reduced. Hence, accuracy in detection of the laser radar device 1 can be increased.

In the embodiment described above, the control unit 14 and the motor driving circuit 8 correspond to a movement control unit.

Embodiments of the present disclosure have been described above. However, the present disclosure is not limited to the above embodiments and can be variously modified.

### [Modification 1]

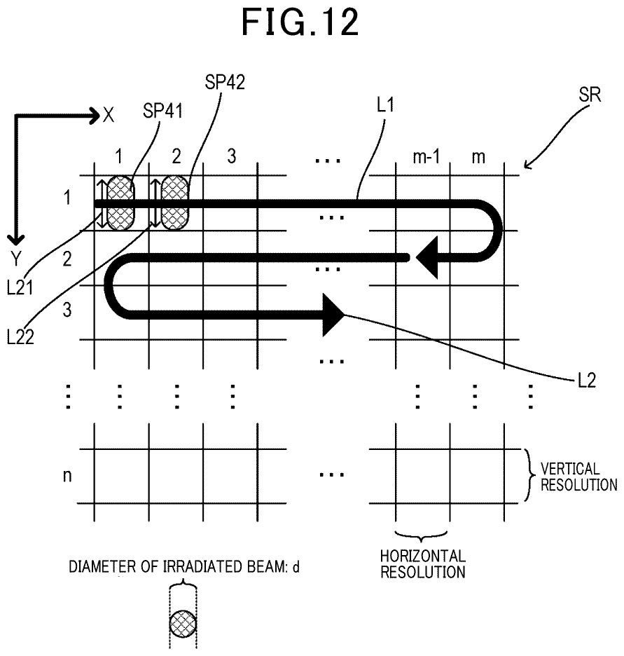

For example, in the above embodiments, irradiation spots are caused to move or oscillate in the horizontal direction in partial regions. However, the direction in which the irradiation spots are caused to move or oscillate is not limited to the horizontal direction. As indicated by irradiation spots SP41, SP42 and arrows L21, L22 in FIG. 12, the irradiation spots may be caused to move or oscillate in the vertical direction in partial regions.

In addition, as indicated by irradiation spots SP51, SP52, SP53, SP54, SP55, SP56 and arrows L31, L32 in FIG. 12, irradiation spots may be caused to move or oscillate in the horizontal and vertical directions simultaneously in partial regions. It is noted that the horizontal direction corresponds to a main scanning direction, and the vertical direction corresponds to a sub-scanning direction.

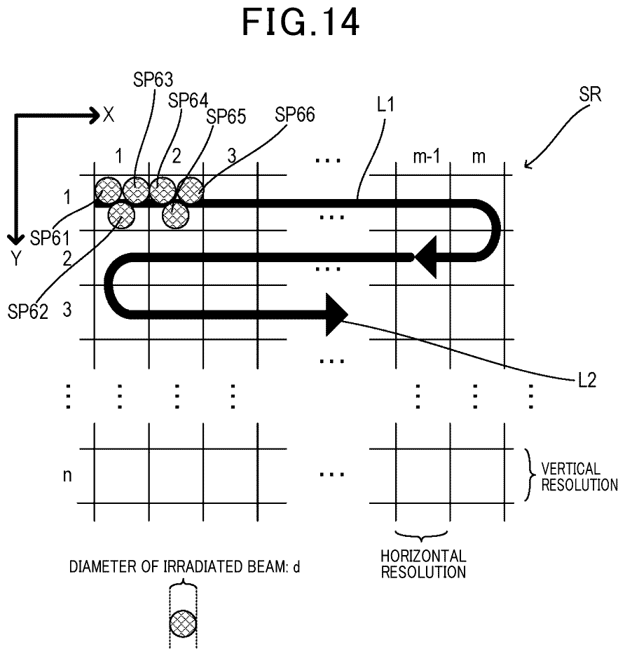

In addition, as indicated by irradiation spots SP61, SP62, SP63, SP64, SP65, SP66 in FIG. 14, a plurality of laser lights may be irradiated to different positions in the same partial region.

### [Modification 2]

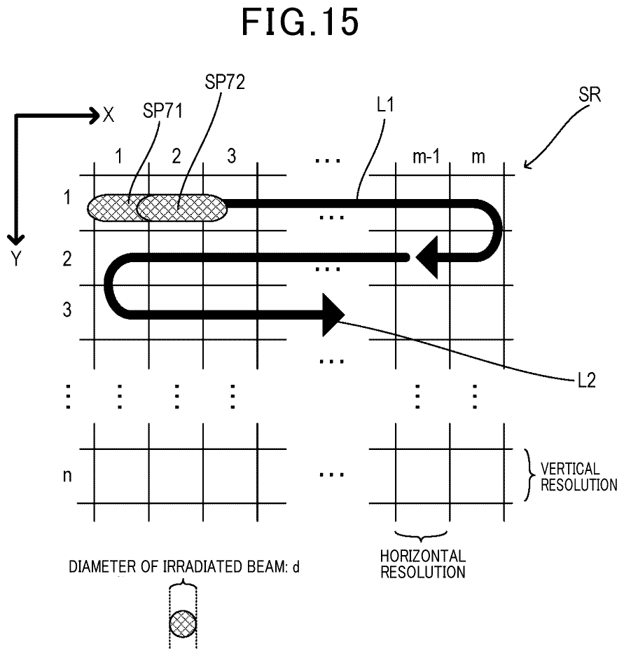

In the above embodiment, irradiation spots are caused to move or oscillate in the same partial region. However, as indicated by irradiation spots SP71, SP72 in FIG. 15, irradiation spots may be caused to move or oscillate to regions beyond one partial region. In the laser radar device 1 described above, the control unit 14 and the motor driving circuit 8 move, for each of a plurality of partial regions, laser light not only in a partial region but also beyond the partial region. Hence, since the laser radar device 1 can increase the number of frequency spectra used for calculating the average of amplitudes of the frequency spectra, the effect of averaging the influence of speckle can be increased, whereby variation in the reception light intensity can be further reduced.

### [Modification 3]

In the above embodiment, scanning with laser light is controlled so that a laser irradiation position moves to a partial region adjacent in the horizontal direction every time the modulating period Tm elapses (i.e., the scanning unit 7 is intermittently driven). However, the control unit 14 and the motor driving circuit 8 may cause laser light to move in a partial region, with Δθ>(1.22*λ/d) being met, by scanning using the scanning unit 7 for, for each of a plurality of partial regions, moving laser light between adjacent two partial region. That is, an irradiation spot may be moved continuously by driving the scanning unit 7 continuously. In this case, the scanning unit 7 is necessary to set a scanning angle, at which scanning is performed at the modulating periods Tm, to be greater than 1.22*λ/d.

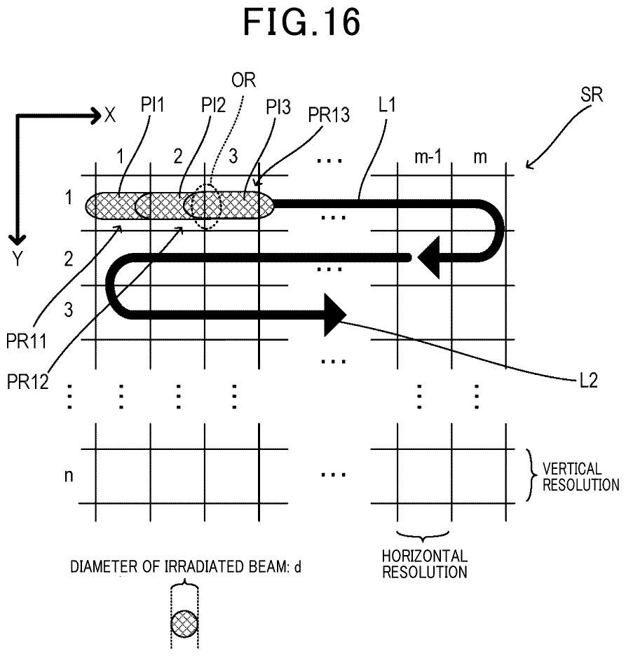

In addition, when the scanning unit 7 is driven continuously, as illustrated by signal processing sections PI1, PI2, PI3 in FIG. 16, the signal processing section for acquiring beat signal waveform data for calculating a frequency spectrum by performing a frequency analysis process may be set so as to acquire beat signal waveform data corresponding to a region beyond one partial region.

In FIG. 16, the signal processing sections PI1, PI2, PI3 correspond to partial regions PR1, PR2, PR3, respectively. However, the signal processing section PI1 includes part of the partial region PR2, the signal processing section PI2 includes part of the partial regions PR1, PR3, and the signal processing section PI3 includes part of the partial region PR2. Hence, for example, as indicated by an overlap region OP, the signal processing section PI2 and the signal processing section PI3 overlap with each other. Thus, since the laser radar device 1 can increase, for each of a plurality of partial regions, the number of frequency spectra used for calculating the average of amplitudes of the frequency spectra, the effect of averaging the influence of speckle can be increased, whereby variation in the reception light intensity can be further reduced.

### [Modification 4]

In the above embodiment, the oscillator 9 is mounted to the scanning unit 7 to cause an irradiation spot to move or oscillate in the same partial region. However, the oscillator 9 may be mounted to the optical window 3 to cause an irradiation spot to move or oscillate.

### [Modification 5]

In the above embodiment, in the additional scanning unit 16, a mirror is rotated by driving force generated by a motor, whereby scanning is performed with laser light. However, the additional scanning unit 16 may perform scanning with laser light using a grating or a liquid crystalline light polarizer.

### [Modification 6]

In the above embodiment, a frequency analysis process is performed by dividing beat signal waveform data into a plurality of fine sections for each of the up-modulation section and the down-modulation section to detect frequencies fbu, fbd. However, the frequency analysis process may be performed without dividing beat signal waveform data into a plurality of fine sections for each of the up-modulation section and the down-modulation section to detect frequencies fbu, fbd.

### [Modification 7]

In the above embodiment, the laser diode 5 irradiates laser light whose frequency has been swept, based on a driving signal output from the laser driving circuit 4. However, laser light irradiated from the laser diode 5 may be input to an external modulator to irradiate laser light, whose frequency has been swept, from the external modulator.

The control unit 14 and the processing thereof described in the present disclosure may be implemented by a dedicated computer which is provided by configuring a processor and a memory that are programmed to execute one or more functions embodied by a computer program. Alternatively, the control unit 14 and the processing thereof described in the present disclosure may be implemented by a dedicated computer which is provided by configuring a processor with one or more dedicated hardware logic circuits. Alternatively, the control unit 14 and the processing thereof described in the present disclosure may be implemented by one or more dedicated computers which are configured by combining a processor and a memory that are programmed to execute one or more functions, with a processor that is configured by one or more hardware logic circuits.

Furthermore, the computer program may be stored in a computer readable non-transitory tangible storage medium, as instructions to be executed by a computer. The method implementing functions of parts included in the control unit 14 may not necessarily include software. All the functions may be implemented by one or a plurality of hardware components.

A plurality of functions of a single component of the above embodiments may be implemented by a plurality of components. One function of one component may be implemented by a plurality of components. A plurality of functions of a plurality of components may be implemented by a single component. One function implemented by a plurality of components may be implemented by a single component. Furthermore, part of the configuration of the above embodiments may be omitted. Furthermore, at least part of the configuration of the above embodiments may be added to or replaced by another part of the configuration of the embodiments.

The present disclosure may be implemented by, in addition to the laser radar device 1 described above, various forms such as a system including the laser radar device 1 as a component, a program for causing a computer to function as the laser radar device 1, a non-transitory tangible storage medium such as a semiconductor memory storing the program, and a distance measuring method.

An aspect of the present disclosure provides a laser radar device (1) including a transmission unit (4, 5), a scanning unit (7), a distance calculation section (14, S10 to S90), and a movement control unit (8, 14).

The transmission unit is configured to transmit laser light that has been subjected to frequency modulation.

The scanning unit is configured to perform scanning with the laser light irradiated from the transmission unit.

The distance calculation section is configured to, for each of a plurality of partial regions obtained by dividing a laser light scanning region preset as a two-dimensional region which the scanning unit scans with the laser light, receive the laser light that has been transmitted from the scanning unit and reflected by an object, and calculate at least a distance to the object in the partial region.

The movement control unit is configured to, for each of the plurality of partial regions, control movement of the laser light so that the laser light moves in the partial region, with Δθ>(1.22*λ/d) being met, where
Δθ is a movement angular range in which the laser light moves in the partial region,
λ is a wavelength of the laser light, and
d is a diameter of the laser light on the partial region.

Since the laser radar device of the present disclosure configured as described above can move an irradiation position of laser light in one partial region, for a plurality of partial regions, the influence of speckle can be averaged, whereby variation in intensity of the received laser light can be reduced. Hence, accuracy in detection of the laser radar device can be increased.

What is claimed is:

1. A laser radar device comprising:
a transmission unit configured to transmit laser light that has been subjected to frequency modulation;
a scanning unit configured to perform scanning with the laser light irradiated from the transmission unit:
a distance calculation section configured to, for each of a plurality of partial regions obtained by dividing a laser light scanning region preset as a two-dimensional region which the scanning unit scans with the laser light, receive the laser light that has been transmitted from the scanning unit and reflected by an object, and calculate at least a distance to the object in the partial region; and
a movement control unit configured to, for each of the plurality of partial regions, control movement of the laser light so that the laser light moves in the partial region, with Δθ>(1.22*λ/d) being met, where
Δθ is a movement angular range in which the laser light moves in the partial region,
λ is a wavelength of the laser light, and
d is a diameter of the laser light on the partial region.

2. The laser radar device according to claim 1, wherein
the movement control unit controls the scanning unit by performing, for each of the plurality of partial regions, feedback control so that a scanning angle oscillates around a target angle corresponding to the partial region to move the laser light in the partial regions, with Δθ>(1.22*λ/d) being met.

3. The laser radar device according to claim 1, wherein
the movement control unit causes the laser light to move in the partial region, with Δθ>(1.22*λ/d) being met, by scanning using the scanning unit for, for each of the plurality of partial regions, moving the laser light between adjacent two partial region.

4. The laser radar device according to claim 1, wherein
the scanning unit further includes an oscillator configured to oscillate a scanning angle of the scanning unit, and
the movement control unit drives the oscillator to cause the laser light to move in the partial region, with Δθ>(1.22*λ/d) being met.

5. The laser radar device according to claim 1, further comprising an additional scanning unit configured to further perform scanning with the laser light transmitted from the scanning unit, wherein
the movement control unit drives the additional scanning unit to cause the laser light to move in the partial region, with Δθ>(1.22*λ/d) being met.

6. The laser radar device according claim 1, wherein
the scanning unit is configured to perform raster scanning with the laser light in a main scanning direction and a sub-scanning direction, and
the movement control unit causes the laser light to move in the partial region along at least one of the main scanning direction and the sub-scanning direction.

7. The laser radar device according to claim 1, wherein
the movement control unit moves, for each of the plurality of partial regions, the laser light not only in the partial region but also beyond the partial region.
